(19) United States
(12) Patent Application Publication
(10) Pub. No.: US 2011/0313720 A1
(43) Pub. Date: Dec. 22, 2011

(54) METHOD FOR IMPROVING FINITE ELEMENT ANALYSIS MODELING OF THREADED CONNECTIONS

(76) Inventors: Ke Li, Missouri City, TX (US); Srinand Karuppoor, Sugar Land, TX (US); Sepand Ossia, Houston, TX (US)

(21) Appl. No.: 13/063,111

(22) PCT Filed: Sep. 3, 2009
(86) PCT No.: PCT/US09/55881

§ 371 Date: Apr. 7, 2011

Related U.S. Application Data
(60) Provisional application No. 61/095,992, filed on Sep. 11, 2008.

(51) Int. Cl. G06F 15/00

(52) U.S. Cl. 702/155

(57) ABSTRACT

A method for improving finite element analysis of threaded connections includes selecting at least one thread parameter for a female connection and a corresponding male connection. In two dimensions a thread form is calculated for the female connection and the male connection based on the at least one parameter. In two dimensions a geometry is calculated of the female connection and the male connection based on the thread form. In two dimensions the female connection and the male connection are segmented into predefined areas. A finite element analysis mesh is calculated based on a predetermined number of nodes for each of the predefined areas and a selected number of mesh layers for each predefined area. The two dimensional female connection and male connection are assembled. The two dimensional mesh on the assembled connections is used as input to a finite element analysis of the threaded connection in three dimensions.

### CROSS-REFERENCE TO RELATED APPLICATIONS

Priority is claimed from U.S. provisional application no. 61/095,992 filed on Sep. 11, 2008.

### BACKGROUND OF THE INVENTION

1. Field of the Invention

The invention relates generally to the field of finite element analysis of response of mechanical devices to applied stress. More specifically, the invention relates to methods for modeling response of threaded connections used in drill strings.

2. Background Art

Drilling wellbores through subsurface rock formations includes suspending a conduit or pipe from a hoisting device such as a drilling rig. The pipe typically has a drill bit at the lower end. The pipe is rotated or portions thereof having the drill bit coupled thereto as caused to rotate. While the bit is rotated, some of the weight of the pipe is applied to the drill bit. The combination of rotation and axial urging of the drill bit causes the bit to drill through the rock formations, creating the wellbore.

The pipe is typically called a “pipe string” assembled from a plurality of pipe segments (“joints”) coupled end to end using threaded connections. The threaded connections perform the function of transferring axial loading, torque and bending loading between the segments of the pipe string. The threaded connections also must form a pressure tight seal so that drilling fluid pumped into the drill string under pressure remains inside the drill string until it reaches the drill bit. Correspondingly, fluid in the wellbore must be prevented from entering the drill string through any leaks in the threaded connections.

As can be inferred from the above description, the requirements for suitable threaded connections used in a drilling pipe string are high. It is known in the art to use a computer operated mechanical design program called “finite element analysis” (FEA) to assist the designer of elements for a pipe string in assuring that the elements of the pipe string are likely to operate as intended. FEA was originally developed for numerical solution of complex problems in structural mechanics, and it remains the method of choice for complex systems. In the FEA, the structural system is modeled by a set of appropriate finite elements interconnected at points called nodes. The elements may have physical (e.g., mechanical) properties such as thickness, coefficient of thermal expansion, density, Young's modulus, shear modulus and Poisson's ratio. Straight elements usually have two nodes, one at each end, while curved elements will need at least three nodes including the end-nodes. The elements are positioned at the centroidal axis of the actual members of the structure being modeled. Three-dimensional elements for modeling 3-D solids such as machine components, dams, embankments or soil masses. Common element shapes include tetrahedrals and hexahedrals. Nodes are placed at the vertices and possibly in the element faces or within the element.

The elements are interconnected only at the exterior nodes, and altogether they should cover the entire domain as accurately as possible. Nodes will have nodal (vector) displacements or degrees of freedom which may include translations, rotations, and for special applications, higher order derivatives of displacements. When the nodes displace, they will drag the elements along in a certain manner dictated by the element formulation. In other words, displacements of any points in the element will be interpolated from the nodal displacements, and this is the main reason for the approximate nature of the solution.

From the application point of view, it is important to model the system such that the following occurs. Symmetry or anti-symmetry conditions are exploited in order to reduce the size of the domain. Displacement compatibility, including any required discontinuity, is ensured at the nodes, and preferably, along the element edges as well, particularly when adjacent elements are of different types, material or thickness. Compatibility of displacements of many nodes can usually be imposed via constraint relations. When such a feature is not available in the particular FEA software, a physical model that imposes the constraints may be used instead. Elements' behaviors should reflect the dominant actions of the actual system, both locally and globally. The element mesh should be sufficiently fine in order to have acceptable accuracy. To assess accuracy, the mesh can be refined until the important results shows little change. For higher accuracy, the aspect ratio of the elements should be as close to unity as possible, and smaller elements are used over the parts of higher stress gradient.

The foregoing considerations have made FEA for threaded connections difficult to use, even though they are highly effective, and subject to inconsistent results because the operator has to both input the element geometry and to select the mesh to the FEA program. It is desirable to have an interface for use with FEA programs that simplifies the initialization of the model geometry and mesh arrangement for use with threaded connections in order to obtain results that are substantially consistent irrespective of the person using the FEA software.

### SUMMARY OF THE INVENTION

A method for improving finite element analysis of threaded connections includes selecting at least one thread parameter for a female connection and a corresponding male connection. In two dimensions a thread form is calculated for the female connection and the male connection based on the at least one parameter. In two dimensions a geometry is calculated of the female connection and the male connection based on the thread form. In two dimensions the female connection and the male connection are segmented into predefined areas. A finite element analysis mesh is calculated based on a predetermined number of nodes for each of the predefined areas and a selected number of mesh layers for each predefined area. The two dimensional female connection and male connection are assembled. The two dimensional mesh on the assembled connections is used as input to a finite element analysis of the threaded connection in three dimensions.

Other aspects and advantages of the invention will be apparent from the following description and the appended claims.

### BRIEF DESCRIPTION OF THE DRAWINGS

FIG. 1 shows a cross section of one example of a threaded connection.

FIG. 2 shows various parameters that may be used to pre-define a thread form for a threaded connection.

FIG. 3A and 3B show, respectively a pin and box connection geometry calculated using input parameters as described with reference to FIG. 2.

FIG. 4 shows segmenting a box connection for calculating meshing for input to the FEA program.

FIG. 5 shows segmenting a pin connection for calculating meshing for input to the FEA program.

FIG. 6A-6C show an assembled threaded connection.

FIG. 7 shows a computer program stored in computer readable media and a programmable computer with display.

FIG. 8 shows an example screen display that may be viewed on a computer display such as shown in FIG. 7.

### DETAILED DESCRIPTION

In a method according to the various aspects of the invention, a finite element analysis (FEA) can be performed on a threaded connection used in a wellbore pipe string. Any known FEA computer program can be used to model the threaded connection, for example, and without limitation, a computer program sold under the trademark ANSYS, which its a trademark of Ansys, Inc., Canonsburg, Pa. Another possible FEA program that may be used with the invention is sold under the trademark ABACUS, which is a registered trademark of Avolution Pty., Ltd., North Sydney, Australia. The principle of the invention is to automate the setup of the dimensions and shape of the threaded connection elements being simulated using a precalculation program for the thread forms, for the male and female thread element geometries, and to preselect mesh element geometry and size to ensure ease of operation and consistency of results.

An example thread connection modeling process according to the invention can include the following, each element of which will be explained in more detail below. First is to calculate the thread form for both pin and box of a threaded connection based on the parameter values (explained below) for the type of thread form chosen or select the thread form from a designated library. Next is to choose the proper pin (male end) and box (female end) threaded connector dimensions. Such dimensions may be selected either with or without stress relief features. The foregoing are calculated as a two dimensional cross section. Next is to select the proper azimuth for the cross-section for the 2-D pin-box connection assembly. The azimuth will depend on the type of stress being simulated, for example, bending stress will result in effective compressive stress on the interior half plane in the direction of the bending stress and effective tensile stress in the opposite half plane. Next is to establish the mesh for the pin and box assembly based on the meshing guidelines explained below.

After the mesh is established, create and run the axi-symmetric FEA model. Then the initial makeup torque is applied to generate the required level of interference in the FEA model to determine the correct thread shoulder interference. If necessary, modify, remesh and rerun the axi-symmetric FEA model that has been updated based on the correct shoulder interference calculated as explained above.

Finally, it is possible to generate a full 3-D FEA model with the suitably sized and correct number of model elements and the proper loads: bending, compression (weight on bit), internal and external pressures. The FEA 3-D model can then be operated to determine the suitability of the design threaded connection.

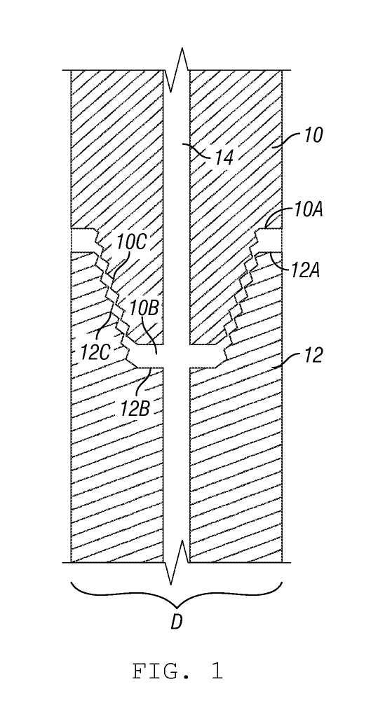

To explain the foregoing procedure, a typical threaded connection used in a drill string or other wellbore working pipe string is shown in cut away view in FIG. 1. A first pipe joint 10 is threadedly connected to a second pipe joint 12. The pipe joints 10, 12 in the present example may be thick walled pipe sections called “drill collars” so that the diameter d traversed by the pipe joints 10, 12 is essentially the same in the vicinity of the threaded connections as elsewhere along the pipe joint. Other types of pipe (e.g., regular drill pipe) may have larger diameter zones proximate the threaded connections (referred to as “tool joints”) than the diameter of the main body of the pipe joint. The first pipe joint may include an inner shoulder 10A at the base of a male, externally threaded coupling (called a “pin”) shown at 10C. The threads will be described in more detail below. A corresponding shoulder 12A on the outer end of a female threaded connection (“box”) 12C may be configured to make interference fit with the shoulder 10A on the pin 10C when the pin 10C and box 12C are assembled. Corresponding shoulders 10B, 12B at the nose end of the pin 10C and the base of the box 12C may also form an interference fit when the threads are assembled. The example thread forms shown in FIG. 1 are only meant to serve as an example and are in no way intended to limit the scope of the present invention.

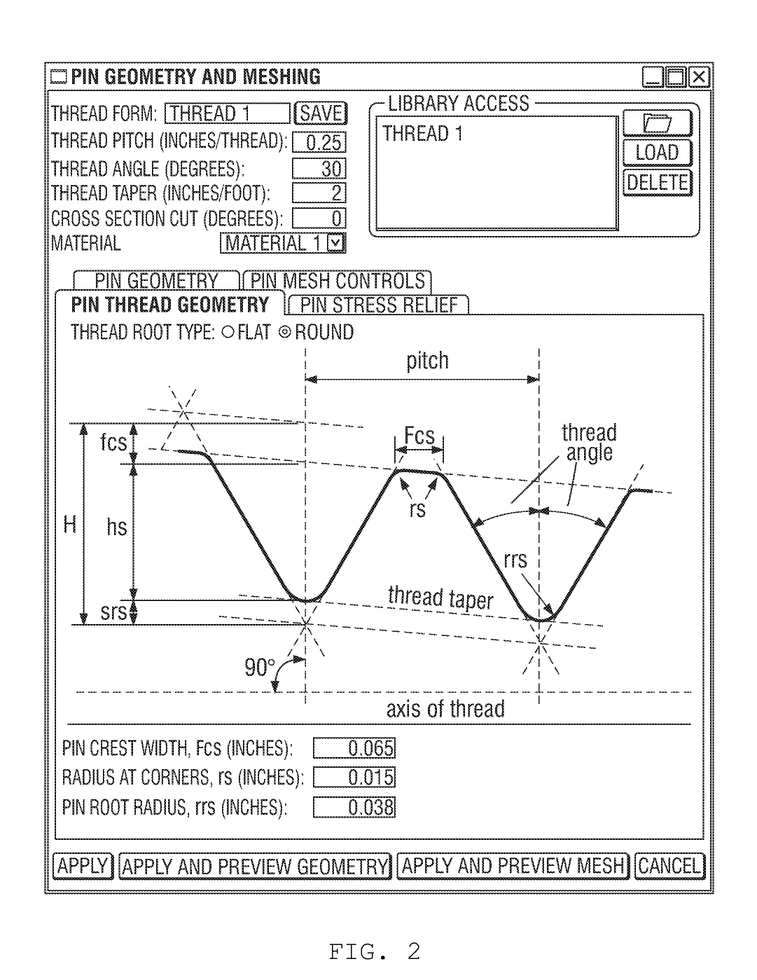

In a first element of a method according to the invention, the form of the threads may be calculated using only a limited set of input parameters. Such parameters may include, for example, as shown in FIG. 2.

TPF=Thread taper, diameter, in/ft (or mm/m)

P=Pitch

H=Thread height

Hn, Hs=Thread height truncated

Fcs=Pin Crest width

Fcn=Box Crest width

Rs=Pin Root radius

Rn=Box Root radius

R=Radius at thread corner

In the present example, a thread geometry is calculated from any or all of the foregoing input parameters. The thread geometry may be calculated using an algorithm that forms part of the user interface to the FEA program. Such calculation will generate a thread geometry for both the pin (10C in FIG. 1) and the box (12C in FIG. 1). What is important about this element of the method is that a substantially identical thread form will be calculated each time the same thread parameters are used as input. Therefore, it is not necessary for the user to explicitly measure the entire threaded connection to set the geometry for input to the FEA program.

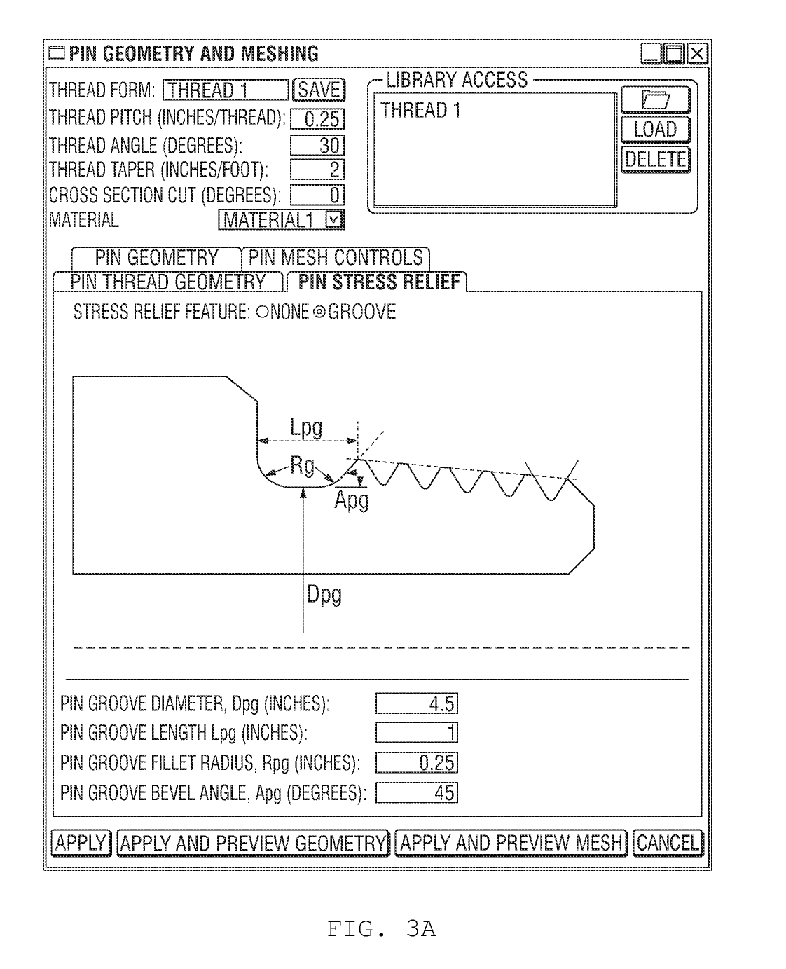

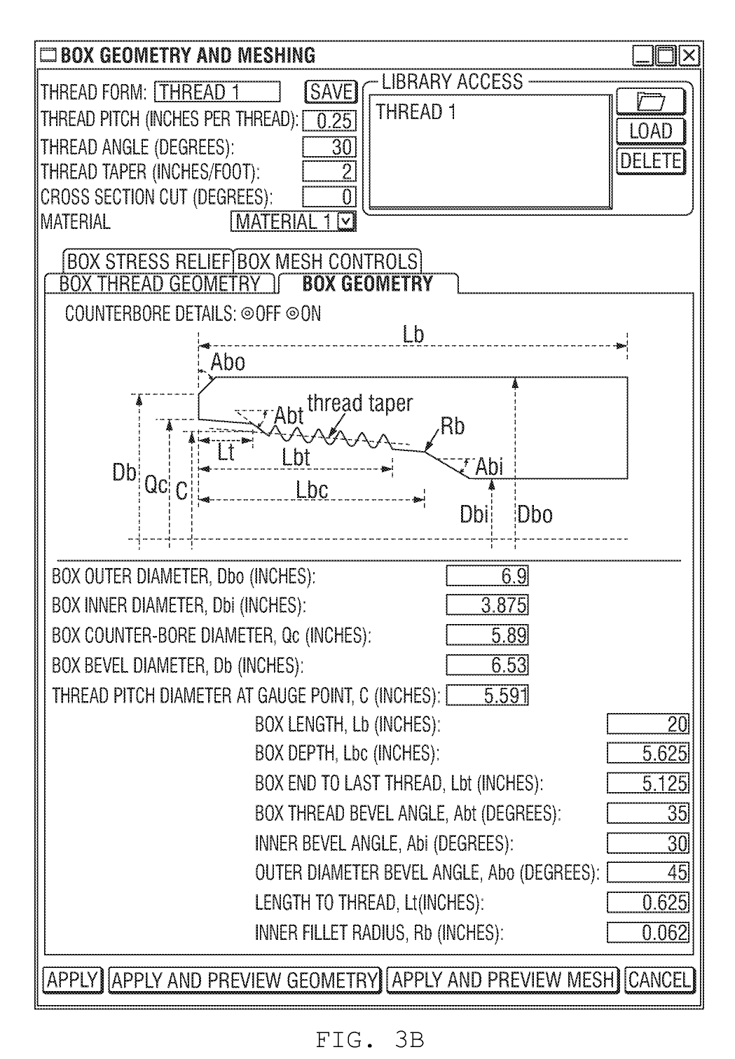

After the thread form geometry has been calculated, a full geometry for the pin and box connections can be calculated from a selected set of input dimensions. For example, the input dimensions may include, as shown in FIG. 3:

Do=Outside diameter, in (mm)

Di=Bore diameter or I.D., in (mm)

D_{F}=Bevel diameter, in (mm)

D_{L}=Large diameter of pin taper

D_{LF}=Flat diameter

D_{S}=Small diameter of pin taper

L_{PC}=Length of pin

C=Pitch diameter at selected distance (e.g., 0.625 in) from shoulder

Q_{C}=Box counter bore diameter

L_{BC}=Length of box

L_{BT}=Length of thread in box

Q_{C}=Box counter bore diameter

Just as for the thread form calculation above, the pin and box geometry calculation may form part of the user interface to the FEA program. A possible advantage of using a calculation for the geometry based on a limited number of connection input parameters is that substantially the same pin and box geometry will be calculated each time if the same input parameters are used. Thus, as in the case of calculation of the thread form, calculation of the pin and box geometry, rather than measurement for meshing as input to the FEA program, may provide more consistent results in determining the actual threaded connection geometry input to the FEA program.

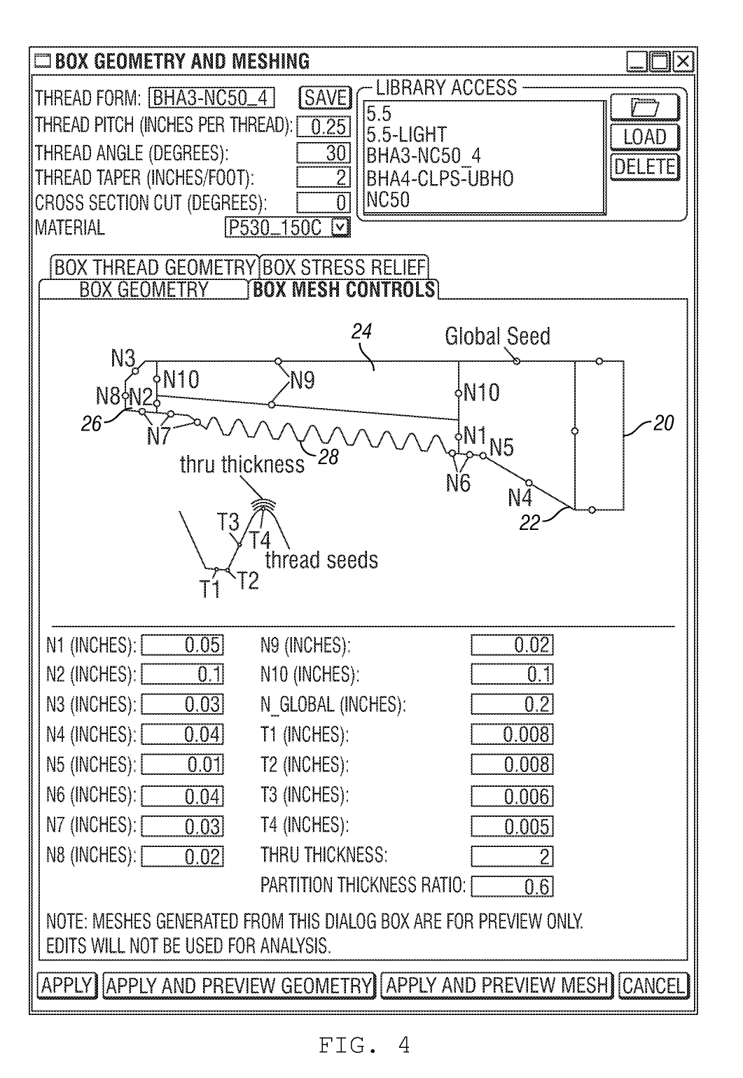

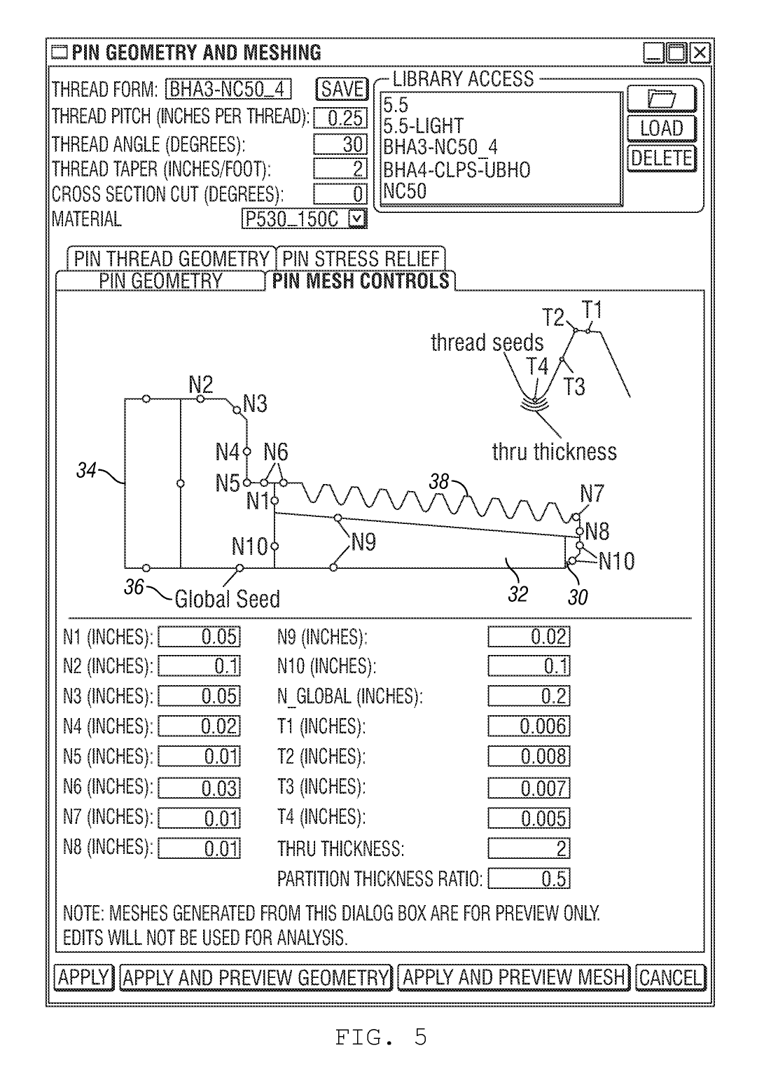

An important aspect of input to FEA programs is meshing. Meshing, as explained in the Background section herein is selection of volume (or in 2 dimensions area) sub elements of the device being modelled that have sufficiently small size and appropriate shape so that forces applied to the modelled device can be accurately simulated. In conventional FEA programs, the user has flexibility to design the shape of the mesh elements and their dimensions. In the present example, the design of the mesh elements may be automatically performed by the computer program based on limited user input. It is expected that such automated mesh design will provide more accurate and consistent results. FIG. 4 shows a cross section of one side of a box connection (e.g., 12 in FIG. 1). The box connection has been segmented into specific portions of the connection, as shown at 20, 22, 24, 26 and 28. Each of the portions can have a default number of mesh elements, and each can have a predetermined mesh element geometry consistent with the overall geometry of the segment. A similar arrangement may be made for the pin connection as shown at 30, 32, 34, 36 and 38 in FIG. 5. For each portion of the pin and box, a number of mesh layers may be selected by the system operator. Based on the selected number of mesh layers, a number of mesh elements and mesh element geometry may be calculated by the computer program. In FIG. 4 and FIG. 5, a preferred spacing of mesh seed elements for the mesh along each surface of each portion is represented by the numbers indicated N1 through N10, and the linear distance between mesh seeds is shown in the corresponding table. A number of layers for each mesh may be indicated as shown in the tables in FIG. 4 and FIG. 5.

By predefining portions of each of the pin and box connections, and selecting a predetermined number of node seeds for each surface on each portion of the thread and box, it is only left to the designer to select a number of layers to define the mesh used in the FEA. By leaving only this one parameter for designing the mesh, it is expected that the results of the FEA will be more consistent irrespective of the system operator or analyst who works on the FEA of the threaded connection.

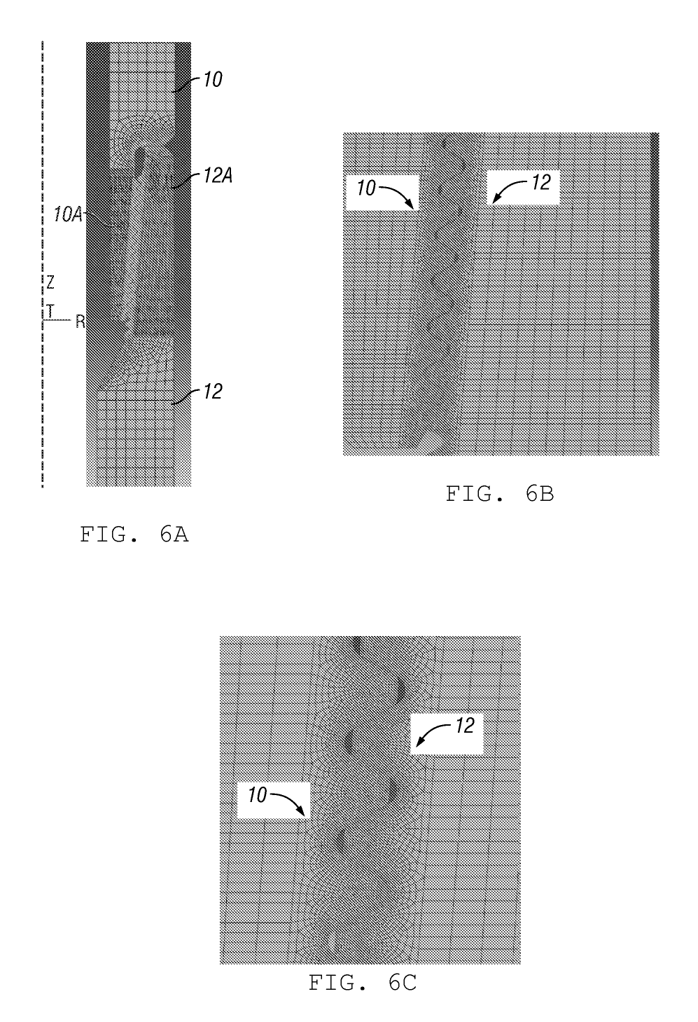

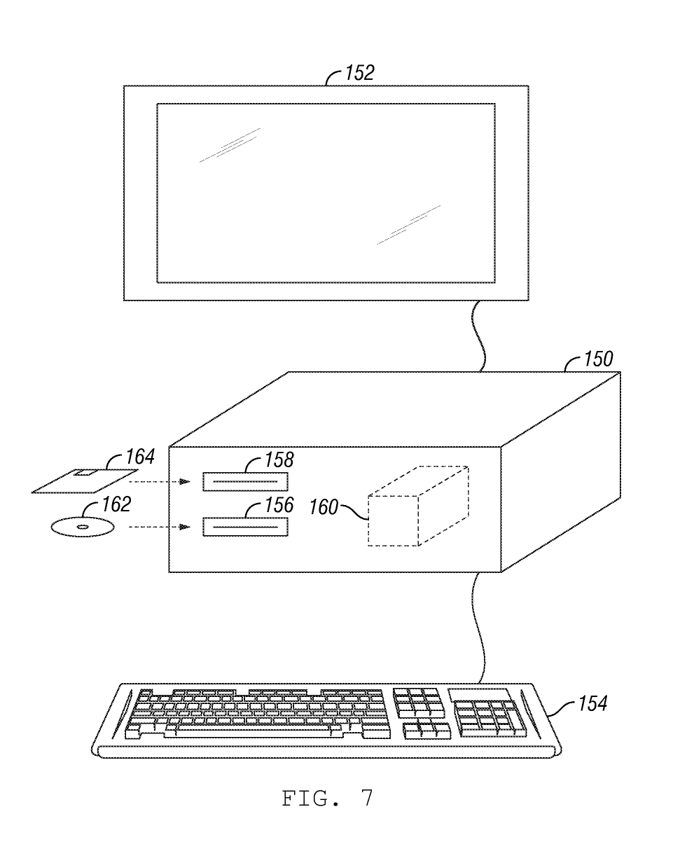

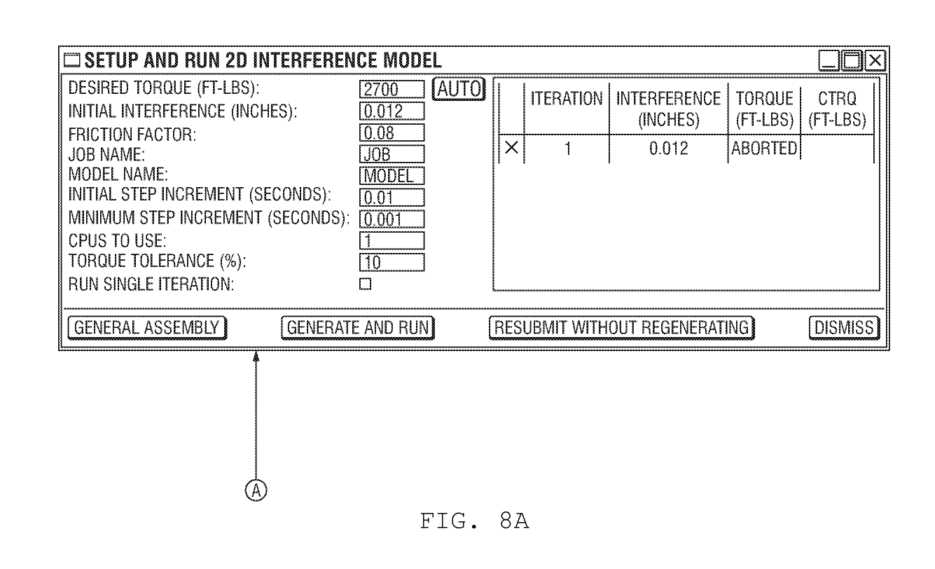

FIG. 6 shows an example of an assembled threaded connection, including the pin 10 and the box 12. During simulated assembly of the threaded connection, it is desirable to ensure that the longitudinal axis of the pin 10 is aligned with the longitudinal axis of the box 12.

It is also necessary in order to perform FEA of the assembled threaded connection to enter the mechanical properties of the materials used to make the components of the threaded connection. For example, for certain types of steel one can assign elastic properties, e.g., Young's modulus=29E6 psi and Poisson's ratio=0.3, to both the pin and the box. Other materials will have correspondingly different properties. During operation of the FEA, ordinary and expected stresses may be applied to the threaded connection, including axial loading, bending stress internal fluid pressure and external fluid pressure as would ordinarily be encountered in a drill string or other wellbore working pipe string.

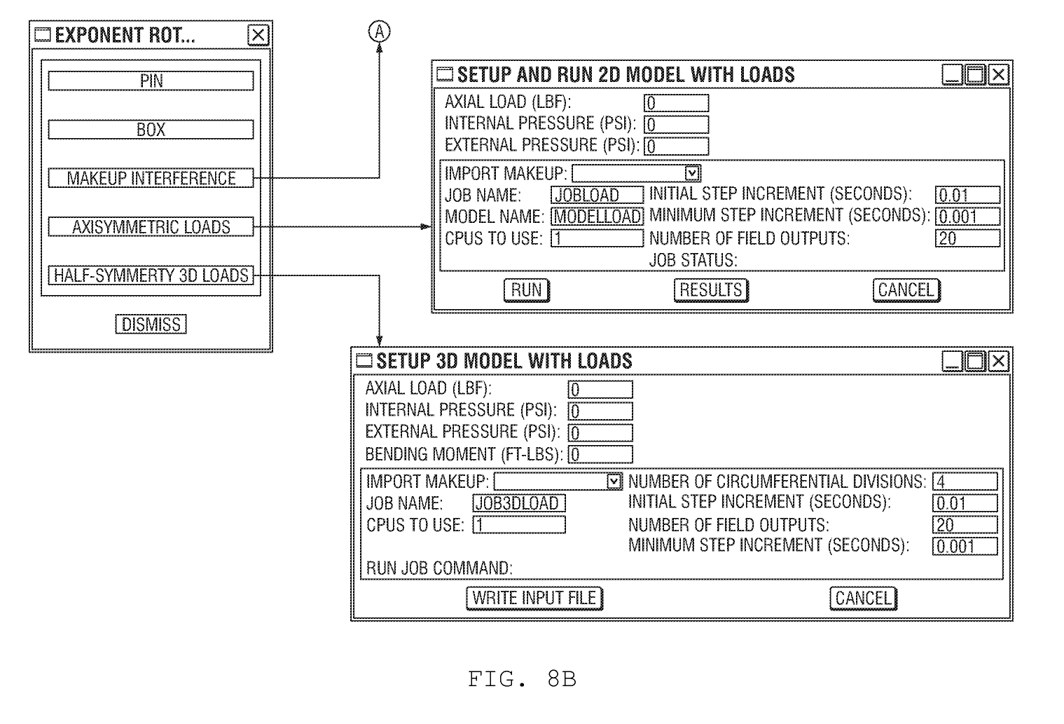

In another aspect, the invention relates to computer programs stored in computer readable media. Referring to FIG. 7, the foregoing process as explained with reference to FIGS. 1-6, can be embodied in computer-readable code. The code can be stored on a computer readable medium, such as floppy disk 164, CD-ROM 162 or a magnetic (or other type) hard drive 166 forming part of a general purpose programmable computer. The computer, as known in the art, includes a central processing unit 150, a user input device such as a keyboard 154 and a user display 152 such as a flat panel LCD display or cathode ray tube display. The computer may form part of the computer that performs the FEA or may be another computer. According to this aspect of the invention, the computer readable medium includes logic operable to cause the computer to execute acts as set forth above and explained with respect to the previous figures. The user display 152 may also be configured to show the results of the FEA determined as explained above. An example screen display for the foregoing procedures is shown in FIG. 8.

Finite element analysis for oilfield threaded connections using precalcuated thread forms, pin and box and predefined mesh based on segments or portions of the pin and box may provide more consistent results in analyzing threaded connections using FEA programs known in the art and may substantially improve the efficiency with which such programs are used to evaluate threaded connections.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. (canceled)

2. (canceled)

3. (canceled)

4. (canceled)

5. (canceled)

6. (canceled)

7. A method for improving finite element analysis of threaded connections, comprising:
selecting at least one thread parameter for a female connection and a corresponding male connection;
generating in two dimensions a thread form for the female connection and the male connection based on the at least one parameters;
generating in two dimensions a geometry of the female connection and the male connection based on the thread form;
segmenting in two dimensions the female connection and the male connection into predefined areas;
generating a finite element mesh based on a predetermined number of nodes for at least one of the predefined areas;
assembling the two-dimensional female connection and male connection; and
using the finite element mesh on the assembled connections as input to a finite element analysis of the threaded connection.

8. The method of claim 7 wherein the step of generating the finite element mesh includes selecting number of mesh layers for each predefined area.

9. The method of claim 7 wherein the finite element analysis of the threaded connection is a three dimensional finite element analysis.

10. The method of claim 7 wherein the at least one thread parameter comprises one of thread taper, thread diameter, pitch, thread height, truncated thread height, width of pin crest, width of box crest, pin root radius, box root radius, and radius at thread corner.

11. The method of claim 7 wherein the finite element analysis includes applying simulated axial loading, bending loading, internal fluid pressure, and external fluid pressure.

12. The method of claim 7 wherein the selecting is performed in a user input field in a graphic user interface on a programmable computer.

13. The method of claim 7 further comprising determining an interference fit on corresponding shoulders of the male and the female connections.

14. A computer program stored in a computer readable medium, the computer program having logic operable to cause the computer to perform steps comprising:
selecting at least one thread parameter for a female connection and a corresponding male connection;
generating in two dimensions a thread form for the female connection and the male connection based on the at least one parameter;
generating in two dimensions a geometry of the female connection and the male connection based on the thread form;
segmenting in two dimensions at least one of the female connection and the male connection into predefined areas;
generating a finite element mesh based on a predetermined number of nodes for each of the predefined areas;
assembling the two dimensional female connection and male connection; and
using the two dimensional mesh on the assembled connections as input to a finite element analysis of the threaded connection in three dimensions.

15. The computer program of claim 14 wherein the step of generating the finite element mesh is automatically determined by the computer program based on the number of nodes.

16. The computer program of claim 14 further comprising logic operable to cause the computer to determine an interference between the male connection and the female connection based on a makeup torque, wherein the interference simulates the same amount of stress in the threaded connection as if the makeup torque is applied.

17. The computer program of claim 16 wherein the interference is between a pin end and a box end of the male connection and female connection.

18. The computer program of claim 14 further comprising logic operable permit a user to select a number of mesh layers for each predefined area.

19. The computer program of claim 14 wherein the at least one thread parameter comprises one of thread taper, thread diameter, pitch, thread height, thread height truncated, pin crest width, box crest width, pin root radius, box root radius and radius at thread corner.

20. The computer program of claim 14 wherein the finite element analysis includes applying simulated axial loading, bending loading, internal fluid pressure and external fluid pressure.

21. The computer program of claim 14 wherein the selecting is performed in a user input field in a graphic user interface on a programmable computer.

22. The computer program of claim 14 further comprising determining an interference fit on corresponding shoulders of the male connection and the female connection.

23. A method comprising:
generating a thread form for a female connection and a male connection having a pin end and a box end;
segmenting in two dimensions the female connection and the male connection into predefined areas;
generating a finite element mesh based on a predetermined number of nodes for at least one of the predefined areas; and
using the finite element mesh on the assembled connections as input to a finite element analysis of the threaded connection.

24. The method of claim 23 further comprising creating the thread form by selecting at least one thread parameter for a female connection and a corresponding male connection.

25. The method of claim 23 further comprising assembling the thread forms of the female and the male connection, segmenting at least one predetermined area of the female and male connection, and performing finite element analysis on the finite element mesh of the predetermined area.

26. The method of claim 23 further comprising determining an interference between the pin end and the box end of the male and female connection based on a torque for the male and female connection, the interference creating an amount of stress in the threaded connection as if the makeup torque is applied.
